(19) United States
(12) Patent Application Publication
(10) Pub. No.: US 2011/0131850 A1
(43) Pub. Date: Jun. 9, 2011

(54) VEHICLE MIRROR SIGN SYSTEM

(76) Inventor: Wes Wiebe, Claresholm (CA)

(21) Appl. No.: 12/883,085

(22) Filed: Sep. 15, 2010

Related U.S. Application Data
(60) Provisional application No. 61/266,573, filed on Dec. 4, 2009.

(51) Int. Cl. G09F 21/04

(52) U.S. Cl. 40/593

(57) ABSTRACT

A vehicle minor message display sign comprising: a writing board having front and back planar dry erase marking surfaces on which non permanent markings may be written, a rim, and a hanger. The hanger is fixedly attached to the writing board to enable the hanging of the writing board from the rearview minor of a vehicle and facilitate the display of the non permanent markings. Sub sequentially the writing board may be disengaged from the rearview mirror of the vehicle, the non-permanent markings may be erased from the writing board with an eraser and the vehicle minor message display sign may be reused.

### CROSS-REFERENCE TO RELATED APPLICATION

The present application is related to and claims priority from prior provisional application Ser. No. 61/266,573, filed Dec. 4, 2009 which application is incorporated herein by reference.

### BACKGROUND OF THE INVENTION

1. Field of the Invention

The present invention relates generally to the field of message display boards and more specifically relates to devices for displaying information from vehicle rearview minors.

2. Description of the Related Art

Many new and used vehicles are sold at dealerships. Vehicles for sale at dealerships may have information and/or sales signs attached to the inside of their windows for customers to read which typically display pricing information and other features, such as model, year, mileage, and like information. The information signs are usually made out of paper or cardboard and the information is printed on them. Since each individual vehicle has different features and price, the paper signs may only be used once. New signs need to be created for each vehicle which creates unnecessary waste and work and is not environmentally friendly. Considering that millions of vehicles are sold through car and truck dealerships every year, the scale of the unnecessary waste production is significant.

Therefore a need exists for a reusable and environmentally friendly information sign that can be temporarily displayed inside a vehicle, viewable from the outside of the vehicle. A need exists for a dry-erase message board which can be used to temporarily display a desired message and which may be reused within a short interval to display a different message. Further, a need exists for a sign of sufficient size to display all the relevant information about a vehicle that is securely attachable to a vehicle and which allows potential customers to view the information customized to the particular vehicle, through the windshield.

Various attempts have been made to solve the above-mentioned problems such as those found in U.S. Pat. Nos. 4,722,145; 5,430,965; 5,099,594; 6,564,981; D234592; and 4,974,355. This prior art is representative of message display boards. None of the above inventions and patents, taken either singly or in combination, is seen to describe the invention as claimed.

Ideally, a device for displaying information from vehicle rearview mirrors should be reusable, be environmentally-friendly, easy to use and store, function reliably and be manufactured at a modest expense. Thus, a need exists for a reliable device for displaying information securable to a vehicle rearview mirror to efficiently display information about a vehicle and to avoid the above-mentioned problems.

### BRIEF SUMMARY OF THE INVENTION

In view of the foregoing disadvantages inherent in the known message display board art, the present invention provides a novel device for displaying information from vehicle rearview minors. The general purpose of the present invention, which will be described subsequently in greater detail is to provide a reusable and environmentally-friendly message display sign for vehicles which is easy to use and store, functions reliably and is manufactured at a modest expense.

A vehicle minor message display sign is disclosed herein comprising: a writing board having front and back planar surfaces, including at least one dry erase marking surface on which a message may be written and displayed for viewing from outside a vehicle and sub sequentially erased. The writing board may be made of melamine, and/or porcelain, or other such suitable material and may be used to display non-permanent markings.

The vehicle minor message display sign preferably further comprises a rim, having a reinforced plastic border, wherein the writing board is encircled by the rim, and a hanger which is fixedly attached to the writing board with a rivet. The hanger comprises a plastic or steel hook of sufficient size to engage the plastic or steel hook about a rearview minor support arm. The hanger is fixedly attached to the writing board to enable the hanging of the writing board from the rearview minor of the vehicle and facilitate the display of the non-permanent markings.

A kit is also described herein including at least one writing board having front and back planar surfaces, at least one rim, at least one hanging means, at least one marking device, at least one eraser (erasing means), and a user instruction manual.

Further, a method of using a vehicle minor message display sign is disclosed herein comprising the steps of: applying non permanent markings on a front and/or back side of a writing board with a marking device, hanging the writing board from the rearview minor of a stationary vehicle and thereby facilitating the display of the non permanent markings, and optionally disengaging the writing board from the rearview minor of the vehicle, erasing the non-permanent markings from the writing board with an eraser, and reusing the vehicle minor display sign.

The present invention holds significant improvements and serves as a vehicle minor sign system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, vehicle mirror sign system, constructed and operative according to the teachings of the present invention.

FIG. 1 shows a perspective view illustrating a vehicle mirror sign system in an in-use condition according to an embodiment of the present invention.

FIG. 2 is a perspective view illustrating the vehicle mirror sign system in an in-use condition according to an embodiment of the present invention of FIG. 1.

FIG. 3 is a perspective view illustrating the vehicle mirror sign system according to an embodiment of the present invention of FIGS. 1 & 2.

FIG. 4 is a flowchart illustrating a method of use for the vehicle minor sign system according to an embodiment of the present invention of FIGS. 1-3.

The various embodiments of the present invention will hereinafter be described in conjunction with the appended drawings, wherein like designations denote like elements.

### DETAILED DESCRIPTION

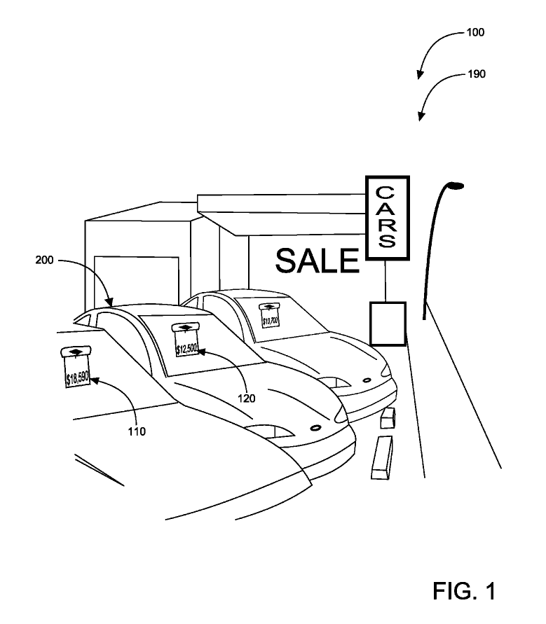

As discussed above, embodiments of the present invention relate to a message display device and more particularly to a device for displaying information from a vehicle rearview mirror as used to display pricing information and feature descriptions of a vehicle. Referring to the drawings by numerals of reference there is shown in FIGS. 1 & 2, a perspective view illustrating vehicle mirror sign system 100 in an in-use condition 190 according to an embodiment of the present invention.

Vehicle mirror message display sign 110 of the present invention within the particular embodiment shown comprises writing board 120 having at least front planar surface 130 and back planar surface 140, rim 150, and hanger 160. Writing board 120 is encircled by rim 150 which comprises a reinforced plastic border. Front planar surface 130 and back planar surface 140 comprise each at least one dry erase marking surface(s) 180 on which non permanent markings 170 may be written with at least one marker. Hanger 160 is fixedly attached to writing board 120 to enable the hanging of writing board 120 from the rearview mirror 210 of a vehicle 200 and facilitates the display of non permanent markings 170.

Non permanent markings 170 may comprise pricing information and feature descriptions of vehicle 200. Vehicle mirror message display sign 110 is hung from rear view mirror 210 of vehicle 200 to create in-use condition 190. Vehicle mirror message display sign 110 can be seen from the outside of vehicle 200 through the windshield of vehicle 200 and thus facilitates the display of pricing information, and other suitable information to browsing customers at car or truck dealerships. Further, vehicle mirror message display sign 110 can be used by private individuals to display virtually any kind of non permanent markings 170 from their vehicle 200.

After use, writing board 120 may be disengaged from rearview minor 210 of vehicle 200 and non permanent markings 170 may be erased from writing board 120 with an eraser. This novel feature gives a user the opportunity to reuse vehicle minor message display sign 110 for a virtually unlimited number of times and provides an environmentally friendly alternative to the commonly used paper or cardboard display signs which need to be thrown away after a single use. In this way the present invention provides a cost-effective solution to the afore-mentioned problems.

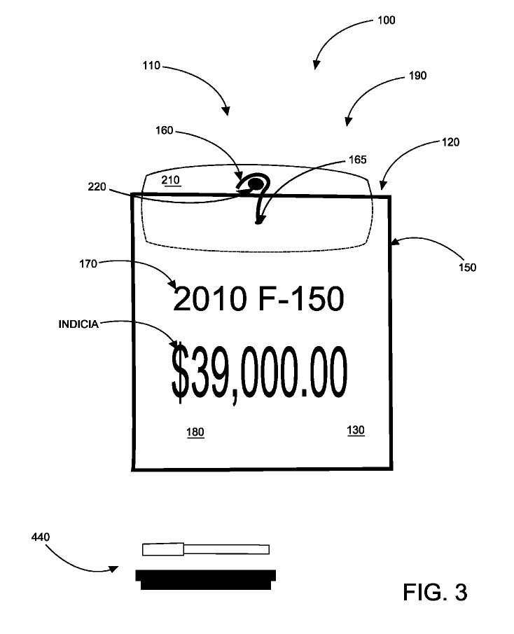

Referring now to FIG. 3, a perspective view illustrating vehicle minor sign system 100 according to an embodiment of the present invention of FIGS. 1 & 2.

Vehicle minor message display sign 110 comprises writing board 120. Writing board 120 may be of rectangular shape and suitably sized to fit in vehicle 200. Writing board 120 comprises front planar surface 130 and back planar surface 140. Front planar surface 130 and back planar surface 140 each comprise dry erase marking surface(s) 180.

Dry erase marking surface(s) 180 comprises a surface which is also commonly used for whiteboards or dry-erase boards on which non permanent markings 170 can be written and sub sequentially erased. Dry erase marking surface(s) 180 preferably comprises a white surface, is very smooth in appearance, comprises a clear coat and is nonporous. Dry erase marking surface(s) 180 in certain embodiments preferably comprises melamine and is affixed to writing board 120. However, dry erase marking surface(s) 180 may comprise any other suitable material(s) such as porcelain, vinyl, acrylic, polyester, etc. on which non-permanent markings 170 may be written with a non permanent marker and sub sequentially erased. Writing board 120 may comprise hardboard, fiberboard, plastic, cardboard, steel or any other suitable backing material.

A special pen (marker) that contains non-permanent ink that can be easily erased may be used to write on dry erase marking surface(s) 180. The ink dries on dry erase marking surface(s) 180 but does not permanently bond to dry erase marking surface(s) 180 so it can be easily removed. User thus may use writing board 120 to display non-permanent markings 170. Non-permanent markings 170 may comprise indicia, such as sale price, make, model and year features and options of vehicle 200 or virtually any other message and/or image(s).

Since vehicle minor message display sign 110 comprises front planar surface 130 and back planar surface 140 which each comprise dry erase marking surface(s) 180, non permanent markings 170 may be displayed to people outside or inside vehicle 200. Vehicle minor message display sign 110 within this particular embodiment comprises hanger 160 which his fixedly attached to writing board 120 to enable the hanging of writing board 120 from rearview mirror 210 of vehicle 200 and facilitate the display of non permanent markings 170 on the inside and outside of vehicle 200. Thus, if a vehicle 200 for sale is situated on the grounds of a car or truck dealership, browsing customers can see non-permanent markings 170 from outside the vehicle 200 through the windshield. Additionally, customers may read more information about the vehicle 200 from back planar surface 140 while sitting in the vehicle 200.

Sub sequentially writing board 120 may be disengaged from rearview mirror 210 of vehicle 200 and non permanent markings 170 may be erased from writing board 120 with a whiteboard eraser, a cloth, a sponge or virtually any kind of eraser that is suitable to erase non permanent markings 170 from writing board 120. This way writing board 120 may be reused for virtually an infinite number of times. This provides an environmentally friendly alternative to paper signs which cannot be altered/changed easily and which typically need to be thrown away after a single use. Considering that millions of vehicles are sold through car and truck dealerships every year, the production of unnecessary waste may be significantly reduced. Vehicle mirror message display sign 110 may be used by professional car dealerships or private individuals who would like to display messages which can be seen from within or from the outside of their vehicles 200.

Writing board 120 may be encircled by rim 150. Rim 150 preferably comprises a reinforced plastic border. However, rim 150 may comprise any suitable material which protects the edges of writing board 120 appropriately from undue wear, such as steel, wood, rubber, etc.

As mentioned before, vehicle mirror message display sign 110 comprises hanger 160. Hanger 160 may be fixedly attached to writing board 120 with fastener 165. Fastener 165 preferably comprises a rivet. However, fastener 165 may comprise any suitable fastening means, such a screws, pins, etc. Hanger 160 comprises a hook of sufficient size to engage about rearview mirror support arm 220 of vehicle 200. Hanger 160 preferably comprises a plastic or steel hook. However, hanger 160 may be made of any material that is lightweight and durable, such as rubber substance, wood, etc. and hanger 160 may have any form which would provide a suitable attachment method for attaching vehicle mirror message display sign 110 to rearview minor 210 such as a loop, etc. Hanger 160 enables the hanging of writing board 120 from rearview mirror 210 of vehicle 200 and thus facilitates the display of non permanent markings 170 on writing board 120 to people inside and outside the vehicle 200. Since hanger 160 is of sufficient size to easily engage with and disengage from rearview minor support arm 220, vehicle minor message display sign 110 can be hung from rearview minor 210 quickly, easily and without complication.

Vehicle Minor Sign System 100 may be sold as kit 440 comprising the following parts: at least one writing board 120 having front planar surface 130 and back planar surface 140 with or without rim 150, at least one hanger 160 (hanging means), optionally at least one marking device, at least one eraser and a user instruction manual. Vehicle Minor Sign System 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

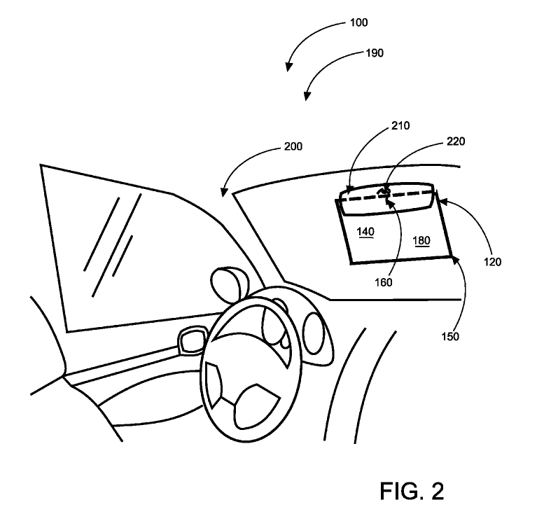

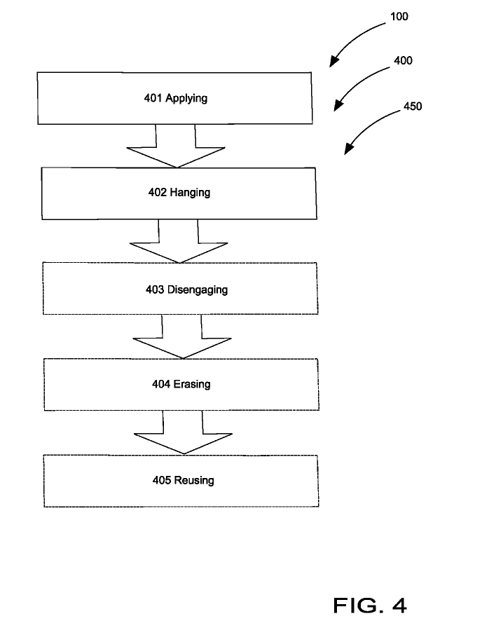

Referring now to FIG. 4, showing flowchart 450, illustrating a method of use 400 according to an embodiment of the present invention of FIGS. 1-3.

In accordance with the embodiments of the present invention a preferred method of use 400 is disclosed herein comprising the following steps: step one 401 applying non permanent markings 170 on a front and/or back side of a writing board 120 with a marking device; step two 402 hanging writing board 120 from a rearview minor 210 of a stationary vehicle 200 and thereby facilitating the display of non permanent markings 170; step three 403 disengaging writing board 120 from rearview minor 210 of vehicle 200; step four 404 erasing non permanent markings 170 from writing board 120 with an eraser; step five 405 reusing vehicle minor message display sign 110.

It should be noted that step three 403, step four 404 and step five 405 are optional steps and may not be implemented in all cases. Optional steps of method of use 400 are illustrated using dotted lines in FIG. 4 so as to distinguish them from the other steps of method of use 400.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle mirror message display sign comprising:
a writing board having front and back planar surfaces;
a rim;
a hanger;
wherein said writing board may be used to display non permanent markings on an erasable surface;
wherein said writing board is encircled by said rim;
wherein said hanger is fixedly attached to said writing board to enable the hanging of said writing board from a rearview mirror of a vehicle and facilitate the display of said non permanent markings.

2. The vehicle mirror message display sign of claim 1 wherein said writing board comprises a dry erase marking surface on said front and back planar surfaces on which said non permanent markings may be written and displayed for viewing from outside said vehicle and said non permanent markings are erasable.

3. The vehicle mirror message display sign of claim 2 wherein said dry erase marking surface(s) comprises melamine.

4. The vehicle minor message display sign of claim 2 wherein said dry erase marking surface(s) comprises porcelain.

5. The vehicle minor message display sign of claim 2 wherein said dry erase marking surface(s) comprises vinyl.

6. The vehicle minor message display sign of claim 2 wherein said dry erase marking surface(s) comprises acrylic.

7. The vehicle mirror message display sign of claim 1 wherein said rim comprises a reinforced plastic border.

8. The vehicle mirror message display sign of claim 1 wherein said hanger is fixedly attached to said writing board with a fastener.

9. The vehicle minor message display sign of claim 8 wherein said fastener comprises a rivet.

10. The vehicle mirror message display sign of claim 1 wherein said hanger comprises a plastic hook of sufficient size to engage said plastic hook about a rearview mirror support arm.

11. The vehicle mirror message display sign of claim 1 wherein said hanger comprises a steel hook of sufficient size to engage said steel hook about said rearview minor support arm.

12. The vehicle minor message display sign of claim 2 wherein said dry erase marking surface displays said non permanent markings on the inside and outside of said vehicle.

13. The vehicle minor message display sign of claim 12 wherein said non permanent markings comprise indicia.

14. The vehicle mirror message display sign of claim 13 wherein said indicia comprise at least one sale price of said vehicle.

15. The vehicle mirror message display sign of claim 13 wherein said indicia comprise make, model and year features and options of said vehicle.

16. A vehicle minor message display sign comprising:
a writing board having front and back planar surfaces,
including at least one dry erase marking surface on which non permanent markings comprising indicia including sale price, make, model and year features and options of a vehicle may be written and displayed for viewing from outside and inside said vehicle and sub sequentially erased,
said dry erase marking surface comprising melamine and/or porcelain, and/or vinyl, and/or acrylic,
wherein said writing board may be used to display non permanent markings;
a rim,
comprising a reinforced plastic border,
wherein said writing board is encircled by said rim;
a hanging means,
said hanging means is fixedly attached to said writing board with a rivet,
said hanging means including a plastic or steel hook of sufficient size to engage said plastic or steel hook about a rearview minor support arm,
wherein said hanging means is fixedly attached to said writing board to enable the hanging of said writing board to the rearview minor of said vehicle and facilitate the display of said non-permanent markings.

17. The vehicle minor message display sign of claim 16 wherein said vehicle minor message display sign further comprises a kit including said at least one writing board having front and back planar surfaces, said at least one rim, said at least one hanging means, at least one marking device, at least one eraser, and a user instruction manual.

18. A method of using a vehicle minor message display sign comprising the steps of:
applying non-permanent markings on a front and/or back side of a writing board with a marking device;
hanging said writing board from the rearview minor of a stationary vehicle and thereby facilitating the display of said non-permanent markings.

19. The method of claim 18 further comprising the steps of:
disengaging said writing board from said rearview minor of said vehicle;
erasing said non permanent markings from said writing board with an eraser.

20. The method of claim 19 further comprising the steps of:
reusing said vehicle minor message display sign.
